(19) United States
(12) Patent Application Publication
(10) Pub. No.: US 2016/0057836 A1
(43) Pub. Date: Feb. 25, 2016

(54) NOVEL POWER AND LIGHTING ARRANGEMENT

(71) Applicant: INTELLIGENT GROWTH SOLUTIONS LIMITED, FIFE (GB)

(72) Inventor: HENRY AYKROYD, FIFE (GB)

(21) Appl. No.: 14/481,114

(22) Filed: Sep. 9, 2014

(30) Foreign Application Priority Data
Aug. 21, 2014 (GB) 1414898.5

(51) Int. Cl. H05B 37/02; H02J 3/00; H05B 33/08

(52) U.S. Cl. CPC H05B 37/0263; H05B 33/0809; H05B 37/0272; H02J 3/00

(57) ABSTRACT

The present invention comprises a novel and improved power and lighting arrangement suitable for use in commercial and/or domestic applications. The invention particularly relates to a controllable system for the provision of power and lighting for commercial and/or domestic applications wherein the system comprises one or more LED lighting arrays and optionally one or more non-LED devices and wherein the lighting and devices are powered by low voltage power distributed on bus bars.

### FIELD OF THE INVENTION

The present invention relates to a novel power and/or lighting arrangement suitable for use in commercial and/or domestic applications. The invention particularly relates to a method for the arrangement and control of powered by low voltage power distributed on bus bars.

The invention also concerns a power and lighting arrangement for lighting devices, light emitting diode (LED) lights, and non-lighting devices, which distributes power and light in a uniform and safe manner.

The invention also concerns a method which allows individual lighting devices, groups of lighting devices or arrays of lighting devices, and non-lighting devices to be individually controlled over large surface areas 1 m² to over 10,000 m² in accordance with the needs of the particular domestic or commercial system.

The invention also concerns a method for the control of wavelength, intensity and photoperiod of individual LED lights (LEDs) in commercial or domestic applications.

The invention also concerns the wiring of LED strips at 12-50 v AC for use in commercial or domestic applications assuring user safety and complying with health and safety electrical standards but not requiring an IP rating.

The invention also concerns the provision of automated control, digital collection and reporting of devices within the system, as well as for the monitoring and management of device-specific features in real-time and the use of feedback loops and evolutionary algorithms linked to pre-set conditions within the system.

### BACKGROUND TO THE INVENTION

Light-emitting diode (LED) lighting technology is known for delivery of increased power efficiency with associated reductions in cost in commercial applications, such as for example in street lighting where previously inefficient/high cost HID sodium lamps were utilised. One of the desirable features of LED fixtures is the ability to control each wavelength independently and to vary the intensities and the photoperiods according to the specific needs of the customised commercial or domestic system.

It is technically possible using LEDs to adjust the photoperiods from milliseconds to hours. LED lighting manufacturers have designed compact LED lighting arrays using conventional printed circuit boards (PCBs) often incorporating 100's of high powered LEDs. These are IP rated and supplied by high voltage, typically 240 v AC.

As over 50% of the power supplied to such LED arrays is typically converted to heat rather than radiant power, these compact LED lighting arrays are often air cooled with fans. Given the ever-increasing awareness of both domestic and commercial consumers of the environmental cost associated with wasted energy consumption, the relative inefficiency of the power conversion provided by commercially available LED arrays can be a deterrent to their use in some circumstances.

Thus, there is a need to provide a power system for such LED lighting arrays which converting more than 50% of the power supplied to radiant power rather than heat energy.

From a commercial perspective it would clearly be of considerable benefit if such LED array(s) could be operated on a more energy efficient basis, and in a cost-efficient manner whilst providing the capacity for remote control of their wavelength, radiant intensities and photoperiods.

Commercially available LED lights are powered with DC current which means that they are typically placed in close proximity to an AC/DC inverter, typically 230 v AC-24 v DC. At low voltage DC there is a significant voltage drop over short distances which mean that for system efficiency the AC/DC invertor must be placed at a distances from the LED lights of less than 5 m, and typically about 2 m.

A particular disadvantage of using LED-based lighting for the provision of lighting for large-scale commercial or industrial applications, or high intensity lighting systems which require high numbers of LED lights, is that the necessary spacing between either the individual LED lights or between groups of the LED lights means that the distance between the AC/DC inverters needs to increase because such arrangements typically mean that the risk of DC voltage drop is increased.

To date efforts to resolve this voltage drop issue for commercial applications have provided modified lighting systems which utilise LED lights, and particularly strips of LED lights, also known as strip lighting in association with an increased number of AC/DC inverters which are smaller in size. In addition to the LED costs indicated hereinbefore, and the additional inverter costs, such modified systems require far higher quantities of high voltage AC wiring, to connect to multiple inverters, than would be required if using a single large AC/DC inverter. This is particularly expensive in large scale commercial systems where all wiring and inverters must be IP rated. In addition, the complexity of such systems means that the measures required for controlling the LED lighting within such modified systems, as well as the measurement of wavelength, intensity and photoperiod generated becomes impractical as well as potentially hazardous should any fault occur.

Thus, there is a need to provide a system for the provision of power and lighting to LED-based lighting arrays which overcomes the voltage-drop restrictions of current systems and is capable of delivering radiant power distribution in a uniform manner, with improved power conversion versus the presently available conventional compact or strip style LED lighting arrays.

### SUMMARY OF THE INVENTION

The present invention comprises a novel and improved power and lighting arrangement suitable for use in commercial and/or domestic applications. The invention particularly relates to a controllable system for the provision of power and lighting for commercial and/or domestic applications wherein the system comprises one or more LED lighting arrays and optionally one or more non-LED devices and wherein the lighting and devices are powered by low voltage power distributed on bus bars.

According to a first aspect the present invention provides an improved power and lighting system suitable for commercial or domestic use wherein the lighting is an LED array comprising LED lights wherein the array is powered by an AC low voltage power supply and
(i) wherein the low voltage AC power distributed to the array is linked to a main transformer which may be positioned externally or internally;
(ii) wherein the low voltage AC power is distributed by bus bars;
(iii) wherein the low voltage AC supplied to each LED light, or group of LED lights is converted to low voltage DC at an AC/DC rectifier associated with each LED light, or group of LED lights;
(iv) wherein the system includes means for automatic control of the output of the LED array as a whole or individual LED lights, or groups of LED lights within the array; and optionally
(v) wherein the bus bars are adapted to power one or more non-LED based devices within the system.

According to a further aspect the present invention provides a novel power and lighting system suitable for commercial or domestic use comprising an LED array which comprises LED lights, wherein the array is powered by an AC low voltage power supply,
(i) wherein the low voltage AC power distributed to the array is linked to an external main transformer,
(ii) wherein the low voltage AC power is distributed by aluminium tubular bus bars,
(iii) wherein the low voltage AC supplied to each LED light, or group of LED lights is converted to low voltage DC at an AC/DC rectifier associated with each LED light or group of LED lights within the array,
(iv) wherein the system includes means for automatic control of the output of the LED array as a whole or individual LED lights, or groups of LED lights within the array, and
(v) wherein the LED lights comprise one or more LED spotlights, one or more LED floodlights, one or more LED strip lights, or one or more strips containing one or more individual LED lights, or any combination of LED spotlights, LED floodlights, LED strip lights, or LED containing strips.

According to another aspect the present invention provides a novel power and lighting system as defined herein wherein power line technology provided via the bus bars provides a control system for the lighting system, wherein the control system communicates with each individual LED light, or groups of one or more LED lights, or one or more arrays of LED lights via use of one or more LED-specific registration chips to provide a remote controlled and monitored system, and wherein automatic correction of voltage drop within the system is managed by local inverters associated with each LED, or group of LEDs within the array.

A further aspect provides a novel power and lighting system as defined hereinbefore having web-based remote-control features and means for the provision of power source blending between peak and off peak main power supplies, and also between a main power supply and alternative, renewable power supplies such as for example solar power.

According to yet further aspects the present invention provides a novel power and lighting system suitable for commercial or domestic use as defined hereinbefore wherein the system additionally comprises one or more of the following independent features, and any combination thereof: the lighting comprises LED strips; the lighting comprises LED spot lights; the lighting comprises LED floodlights; the lighting comprises a combination of LED spot lights, LED floodlights and/or LED strips; the combined power line and array registration enables wireless remote control and monitoring of the system; the system includes a feedback loop in the control system to enable real-time LED adjustment within buildings.

According to a still further aspect the present invention provides a novel power and lighting system suitable for commercial or domestic use as defined hereinbefore wherein each individual LED light, and/or non-LED device, or group of lights and/or non-LED devices, or array of lights and/or non-LED devices within the power and lighting system can be individually registered for control ultimately via the internet with all data collected via cloud internet with such control enabled by a power line communications chip.

These aspects and yet further aspects of the invention are described hereinafter.

### DESCRIPTION OF THE INVENTION

The Applicant has found that unprecedented efficiencies in terms of lighting and/or heating/power costs are provided via use of the present power and lighting system comprising the use of aluminium bus bars and low voltage (<50 v AC) for power distribution to one or more LED arrays.

In particular, the Applicant has found that bus bars at low voltage AC can be advantageously used to power LED lights, individually or in groups, within one or more LED arrays within commercial and/or domestic applications buildings.

The Applicant has also found that ‘power line’ technology, provided via the bus bars provides a desirable control system for the lighting system, wherein the control system communicates with each individual LED light/groups of one or more LED lights or one or more arrays of LED lights via use of one or more LED-specific registration chips for identification and control of individual lights or groups of lights to provide a remote controlled and monitored system, and wherein automatic correction of voltage drop within the system is managed by local inverters associated with each array.

Advantageously, use of the present improved power and lighting system removes the need for any high voltage AC supplies near the commercial or domestic environment in which the present power and lighting system is to be employed, and ideally removes any high voltage AC to a remote or external location.

A remote location as defined herein means either a location which, although internal to the building, is at a remote location in relation to the lighting system, such as for example to a plant room, or the like.

The combination of the desirably flexibility of lighting provided by the power and lighting system herein in conjunction with the unprecedented efficiencies in terms of lighting and/or heating/power costs deliverable via the use of bus bars and low voltage (<50 v AC) for power distribution, and the attractive control system means that the present power and lighting system has manifold applications in both commercial and non-commercial/domestic applications.

In particular the Applicant has found that aluminium bus bars, at low voltage AC, can be used to power LED lights, individually or in groups, within one or more LED arrays within commercial and/or domestic applications buildings where ‘power line’ technology, provided via the bus bars, provides a control system for the lighting system, wherein the control system communicates with each individual LED light/group or array via use of one or more registration chips for identification.

The Applicant has also recognised that the novel use of bus bars, at low voltage AC as detailed herein is useful for providing power to non-lighting specific devices in domestic and/or commercial applications. For the avoidance of doubt, any low-voltage compatible device may be powered via the presently proposed system via connection into the system via a device-specific registration chip and a local device-specific inverter/controller incorporated into the device lead with a suitable plug. For example, in exemplary domestic or commercial systems one or more devices such as laptops, personal computers (PCs), printers, scanners, dictation machines, telephone answering machines, chargers including mobile-phone chargers, tablet chargers, mobile gaming device chargers, camera and video chargers, TVs, monitors, shavers, hair trimmers, radios, smoke alarms/detectors, CO₂ alarms/detectors, security alarms and sensors and the like can be powered using the present system. Sound systems including either domestic surround sound or whole house systems, as well as large scale commercial sound systems are also suitable arrangements for power distribution to and remote control management thereof via the present bus bar arrangements and either power line or local/repeater wireless technology.

Advantageously power line technology, combined with registration chips on each array, gives total remote-control and monitoring of either the lighting or the combined power and lighting systems herein. Such remote control not only has advantages in relation to the maintenance of power usage, it also enables the set-up of controllable domestic and/or commercial systems which can be tailored/pre-programmed to change during specified time-periods (minutes, hours, days, weeks, months) according to the particular needs of the user.

Further advantage of the web-based remote-control features of the power and lighting system for commercial and/or domestic applications herein is the ability to efficiently carry out power source blending between peak and off peak main power supplies, and also between a main power supply and alternative, renewable power supplies such as for example solar power.

Whilst the total number of LEDs within the system, and their arrangement within it will be dependent upon the needs of the particular commercial and/or domestic application, advantageously the combination of the present system and power line technology provides the ability to manage and control systems having 100,000 or more individual LEDs. The present system provides freedom in relation to the spacing of any of the LED lights as defined herein from one another as well as the relative positioning of groups of one or more LEDs from each other within the array.

An advantage of a lighting feedback loop is the ability of the system to react to external (non-LED array-associated) light levels such as for example light sensors and lighting needs such as for example motion sensors to provide optimal efficiency on an on-going basis.

Advantages of the non-LED device feedback loop is the ability of the system to react to local environmental factors such as for example motion sensors to provide power to non-lighting devices such as for example PCs, screens, and such like in low-activity areas effectively on demand.

The LED lights and non-LED devices for use within the present system can be controlled independently using a wireless link to a local PC or via the internet remotely. Each LED light, LED light fitting, or non-LED device for use in the system is fitted with a registration chip which can be identified and controlled separately.

According to a yet further aspect the present invention provides a control system for lighting devices and non-lighting devices within the system as defined herein wherein the lighting control system includes means for logging of data for measurement of radiant power and wherein the non-lighting control system includes means for logging of data for measurement of power consumption.

For the avoidance of doubt the lights and devices which are controlled via the present power and lighting system include: LEDs as defined herein, wherein said LEDs may be controlled independently, individually, in one or more groups, or as one or more independently controllable arrays; and non-lighting/non-LED specific devices as defined herein wherein said non-lighting/non-LED specific devices may be controlled independently, individually or in one or more groups.

Each LED light, group of lights, LED strip, group of LED strips, strip containing one or more LED lights, or group of strips containing one or more LED lights, within a lighting array for use in the present power and lighting systems can be controlled independently using a wireless link to a local PC or via the internet remotely. Each LED light or group of LED lights, within an array is fitted with a registration chip which can be identified and controlled separately.

The Applicant has also found that in addition to power line technology the present power and lighting system comprising low voltage AC distributed via bus bars to one or more LED arrays wherein the array(s) have local registration chips is highly compatible with local/repeater wireless technology. For power and lighting systems herein which require the capacity to deliver significant/strong wireless signal strength, such as for example in applications where internet access is required, local/repeater wireless technology can be advantageously employed.

Domestic applications as defined herein are domestic buildings including: houses and outbuildings associated with houses, such as and including sheds, garages, outhouses, garden rooms, and domestic greenhouses and the like.

Commercial applications as defined herein include: commercial buildings; buildings including primarily offices/spaces for desk-based-work; buildings and/or warehouses suitable for material handling, and/or storage; factory or manufacturing buildings suitable for the preparation of goods; research facilities; hospitals; airport terminal buildings; and the like. As will be appreciated by the skilled person, any building where efficiencies in power and/or lighting are desirable can be adapted for use with the present system either in whole, or in part depending upon the requirements of the particular building.

Further commercial applications include: street lighting; floodlighting; lighting in parks and public spaces; car park lighting.

Advantageously, the present system provides for the first time an effective “plug and play” system for complex power and lighting systems which can be designed and changed by the user in accordance with the desired commercial or domestic system to be accommodated and then the individual LEDs, or groups or LEDs, and one or more non-lighting devices can be registered and routinely calibrated as detailed hereinafter.

Exemplary arrangements for use of the present system for the provision of power and lighting in commercial and domestic applications are discussed hereinafter and illustrated by the figures.

### Power Supply and Control Functions

The applicant has found that aluminium bus bars, at low voltage AC, can be used to power complex systems comprising LED lights, individually or in groups, within one or more LED array in combination with one or more non-LED devices, within commercial and/or domestic applications buildings where ‘power line’ technology, provided via the bus bars, provides a control system for both the lighting devices and non-lighting devices within the system, wherein the control system communicates with each individual LED light, or non-LED device, or groups thereof, or array(s) of LEDs lights via use of one or more registration chips for identification.

For non-lighting devices, such as for example a mobile phone charger, the charger plug is connected to the low voltage AC supply which is converted to DC by a suitable inverter which can be incorporated into either the device lead or into the charger plug. Each non-lighting device can be monitored and/or controlled independently using a wireless link to a local PC or via the internet remotely via the combination of a local individual controller containing a suitable pre-registered chip, which is incorporated into either the device lead or into the charger plug.

As detailed hereinafter the LED lights are powered by low voltage AC, as distributed and supplied by a bus bar assembly. The low voltage AC is converted to DC on each LED light, or each LED light fitting, at the end of each strip by using an appropriate rectifier. Each LED light, or groups of LED lights within the array(s) can be monitored and/or controlled independently.

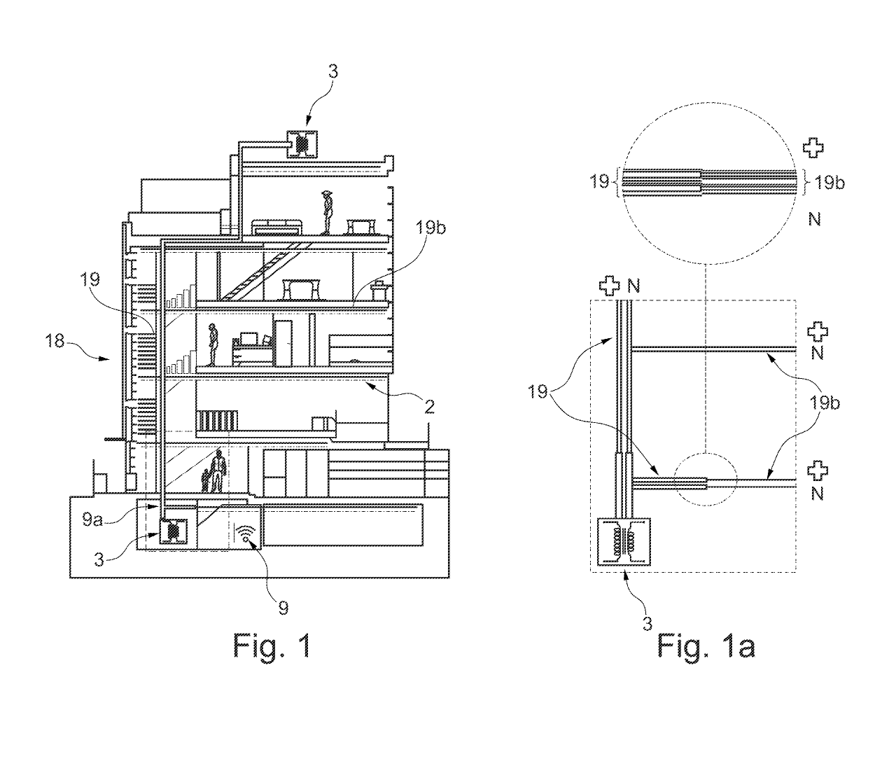

As detailed herein powerline technology, associated with the bus bar assembly, is advantageously employed to provide control of the system. Further and/or alternative control system features such as the use of a wireless link to a local PC or via the internet remotely are detailed hereinafter. A representation of a section of an power and lighting system incorporating powerline technology, is illustrated in FIG. 1a.

According to a further aspect each LED light, or non-LED device herein, including individual LEDs strips, groups of LEDs within an array, one or more arrays of LEDs, individual non-lighting device, or a group of non-lighting devices can be individually controlled ultimately via the internet with all data collected via the cloud.

Such control is provided by a local PC linked to a central microcontroller which is wireless enabled. For example, one LED within a group of linked LEDs, receives the wireless signal and distributes the command to each individual LED within the group. Alternatively power line technology via the low voltage AC supply can be used to provide this control. These same control wires and wireless signals are two-directional and able to send commands and collect data from local sensors and other monitoring equipment.

Further advantages of the controllable, low cost, high efficiency, power and lighting systems of the present invention comprising LED lighting and non-LED devices are the ability to build-into such systems unique identifying information and the ability to drive-down installation and running efficiency costs yet further via the utilisation of power line technology.

For LEDs in particular, such local controllers are able to vary the voltage and current from zero to typically 200% of the LEDs design specification where 100% is the optimum or ‘sweet spot’ where the ratio of radiant power to electrical power is at its maximum. Current boost above the ‘sweet spot’ can be beneficial where ‘off peak’ power costs are available. The microcontrollers can also pulse in order to control light intensity and photoperiod by pulse wave modulation (PWM). They can also vary the voltage, current and pulse simultaneously.

For LEDs, to enable advantageous lighting system control each LED, group or strip of LEDs is fitted with a registration chip which can be identified and controlled separately. On installation each strip is calibrated over the range of input currents and ‘on-off’ pulse widths using a purpose designed spectrometer or spectroradiometer thus enabling the control system to deliver and record the wavelengths, intensities and photoperiods delivered by each strip. This enables the manufacturers of LED bin selections to be corrected to compensate for LED production variances. It also enables many more bins of LEDs to be bought thus reducing cost. Over time the LEDs deteriorate and require more electrical power for the same radiant output power. By periodically recalibrating these variances become known and can be adjusted for. Further by collecting the input power data over time (years) the deterioration can be predicted and strip replacement can be optimised. The calibration also allows for faults to be identified and early replacement undertaken. The calibration process also allows for automated LED cleaning with associated benefits for system efficiency as well as ancillary cost-savings for physical cleaning.

LED calibration may be carried out on manufacture, on installation into a system, or as required during the life-cycle of an LED, such as for example on fixing an LED light or LED light fitting into an array. For optimal control efficiency an LED for use in the present system should be calibrated before it is registered. Any suitable calibration process may be used to calibrate LEDs for use in the present systems prior to their registration and utility. In an exemplary LED calibration process suitable for use herein the following steps are carried out:

1. Each LED, or if all the LEDs within a group of LEDs within the array are identical, then one LED from each group by bin, would be manually connected to the AC low voltage supply via an appropriate bus bar or wire and inserted into a ‘dark box’.
2. A pre-set combination of currents and PWM sequences would be run and the resultant data would be logged as relating to all the LEDs used in the system from that bin. Where there are more complex systems containing different groups of LEDs and/or LEDs from different bins, then steps 1 and 2 would be repeated in respect of each differently sourced LED.
3. The relevant resultant data-set would be allocated to the registration chip for each group of LEDs within the array which contains the LEDs from the logged bin number.
4. Once the system is up and running with the calibrated, registered LEDs then, in the future when any of these combinations are used the data will be known and can be mapped for the areas within the building/array under each LED or group of LEDs.

As detailed hereinbefore the LED lights for use here are ideally calibrated and registered prior to the array being operated. Each LED has a ‘serial identifier chip’ to provide serial registration which means that the LED calibration information would be stored against this unique number.

As detailed hereinbefore the invention provides a power and lighting system including an LED array having communications functionality.

Power line technology provides the ability to include communications functionality on top of an existing AC supply waveform. Thus in addition to the advantages and benefits of the improved LEDs for use in systems as detailed herein, the invention provides as a further aspect an LED array as detailed herein having communications functionality.

Thus according to a further aspect the power and lighting system of the invention provides means for independent control of the wavelength intensity and photoperiod of each LED light, or groups of LEDs, within the one or more LED arrays used in the present systems over large areas 1 m² to 10,000 m². By registering the LEDs or groups of LEDs upon installation, or periodically thereafter, the radiant power of the overall system, individual strips or groups of strips within the system over a range of input currents is known.

Each registered LED can be recalibrated using a spectoradiometer as required. This process allows for repeatability and data logging of the radiant power delivered by the lighting aspect of the present system to be measured, and for the first time provides information in real-time as to the radiant power being delivered to the users, either across the system, or within individual sections, segments, offices, floors, factory lines, or other such pre-determinable sectors of the system wherein these individual areas within the system are aligned to corresponding LEDs or groups of LEDs within the one or more arrays as defined herein before and as utilised in the present power and lighting system.

The present control system for the LED array(s) as defined herein uses smart software to manage the data being captured and relayed to the control system from various sources, lighting registration chips, inverter/rectifier monitoring means, power line communications chip, wireless technology, local PCs, or other data capture means, in order to provide tailored monitoring and control of the overall growth system.

Advantages of the present power and/or lighting system versus present commercially available systems include: two-step voltage inversion; efficiencies of from 90 to 94%; means for self-regulating system control; provision of automatic voltage correction; ability to control arrays containing more than 100,000 LEDs via use of power line technology; more efficient wiring system with only final wiring being required, and being provided via copper wire; provision of a “plug and play” LED array; use of wireless link(s) to local sensors within the system as part of the management and remote-control of features within the array(s).

In addition, as such systems provide unprecedented efficiencies in running costs, versus current 24/7 monitored systems, as well as being less capital intensive to set-up, typically in the region of 30% cheaper, the present power and/or lighting system provides for the first time means to deliver bespoke LED lighting, and/or power to non-LED devices in commercial and/or domestic applications via a system which is reliable, efficient, sensitive, remotely-controlled.

### Transformers

Suitable transformers for use in the present systems are 240-50 v AC RMS transformers. As will be appreciated such a transformer can be sized to supply either a single building or a series of buildings, or a series of sections within a single building to provide capacity of thousands of metres square. For safety reasons such transformers are generally located externally. To optimise system efficiency larger transformers are preferred, and as such when a new power and lighting system for a commercial or domestic application is being designed the current and future capacities should be considered to ensure that the system is designed to deliver both initial and on-going efficiency. In general, larger transformers provide greater the efficiency, typically in the region of 95-99% or more.

The present power and lighting system provides LED lighting for commercial and/or domestic applications having electrical and radiant efficiency benefits versus conventional systems.

The present system can provide electrical efficiencies in the region of: greater than about 80%; greater than about 85%; about 87% in combination with radiant efficiencies (wall plug efficiencies) in the region of: greater than about 30%; greater than about 35%; greater than about 40%; about 43%.

The present systems utilise 240 v AC to 24/50 v AC transformers which can be up to 99% efficient at large scale, in combination with local rectifiers on each LED light. Such rectifiers can be selected for optimal efficiency levels, and ideally in the region of about 95% efficient. By use of the present control system having 95% efficiency the present system is capable of providing electrical efficiencies in the region of 87% (99%×95%×95%), which corresponds to about 43% wall plug efficiency (50%×87%).

According to a further aspect the present invention provides a controllable power and lighting system as defined herein which includes LED lighting, and utilises 240 v AC to 24/50 v AC transformers in combination with local rectifiers on each LED strip.

Representations of domestic and commercial systems system utilising this efficient power and lighting system are illustrated by the Figures herein.

To accommodate commercial systems such as for examples warehouses having very large footprints of thousands of metres square, the Applicants have designed a modified system wherein the main large transformer can be installed at a remote point inside the warehouse with power being distributed to the lighting array and any non-LED devices as desired via the bus bar assembly and having the remote control features as defined herein. Only the internal cabling to the transformer would need to be IP rated with the remainder of the system being as defined hereinbefore.

For the avoidance of doubt, in the present power and lighting systems for commercial and/or domestic applications the main AC transformer can be located internally or externally. Where the present system is incorporated into a commercial and/or domestic building having one or more AC transformers, the main AC transformer can be located externally, at a central location to the system, or internally either centrally, or at the top or at the bottom of the building according to the particular building requirements. A central location as defined herein includes: a position central to the system; a plant room; a central plant room; a position central to a group of rooms, floors, offices, or buildings and the like which are powered by the present power and lighting system.

Thus the invention additionally provides a power and lighting system suitable for use in commercial and/or domestic applications comprising an external or internal main AC transformer, wherein when the main AC transformer is internal to the building it may be positioned centrally or at the top or at the bottom of the building, and wherein when the main AC transformer is external it is positioned at a central location.

According to a further aspect the present invention provides a novel lighting system suitable for commercial or domestic use as defined hereinbefore wherein the system additionally comprises provides means for protecting the lighting arrangements in systems from electrical power surges via the use of transformer related surge protection equipment on the high voltage side of the transformer. Any suitable surge protection equipment, also known as surge protection devices, surge suppression devices, or transient voltage surge suppression equipment capable of protecting against surges or spikes in the low voltage AC being supplied from the transformer into the system can be used. As will be appreciated the selection of any particular surge protection equipment will be dependent upon the particular low voltage AC level being supplied to any particular system in accordance with the present invention.

Thus the present invention provides a novel lighting system suitable for commercial or domestic use in accordance with any of the aspects defined herein wherein the system additionally comprises provides means for protecting the lighting arrangements in systems from electrical power surges.

### LEDs

An LED is a light emitting diode and any suitable LED may be utilised in the lighting arrays for use in the present power and lighting systems. Typically, the LEDs for use in any particular commercial or domestic system are selected for their ability to provide light across the desired wavelength range, or at a particular wavelength for a specific section of a system.

In the power and lighting systems herein for domestic and/or commercial systems the LED lights can be spaced according to the preference of the user and the levels of light required in any particular environment.

Any commercially available LED lighting which can be hosted upon bus bars, and can be adapted to incorporate a local registration chip as defined herein, may be used in the present power and lighting systems. For the avoidance of doubt, whilst the present power and lighting systems are primarily directed to the provision of white/broad spectrum LED lighting, LED lighting providing bespoke LED coloured light either throughout, or in specific segments or sections of the system can also be delivered via the present systems via use of specific LEDs.

The choice and selection of the particular LEDs for use within the present systems will be dependent upon the commercial and/or domestic applications. As will be appreciated in more complex applications different LED lighting may be used in different sections, rooms, floors, or otherwise defined segments of the building to be lit. The number of LEDs which can be incorporated into the LED array(s) of the present power and lighting system is limited only by the relative scale of the particular commercial or domestic application into which the system is to be applied.

Advantageously the present power and lightings system provides LED arrays which can be designed on a room by room, section by section, or floor by floor basis according the needs of the particular environment to be powered and lit.

Use of the present arrays enables for the first time the potential for unprecedented numbers of LEDs to be utilised in large-scale commercial systems comprising millions of LEDs. Advantageously the present arrays can be controlled individually, in groups, or all together in a practical manner. As detailed herein the degrees of control provided by use of the present system provides unprecedented levels of flexibility.

For the avoidance of doubt, and according to a particular aspect, each LED light, or strip, or each LED light fitting, contains a local rectifier, or inverter, for the conversion of the low voltage AC into DC inside the LED. Each LED strip, or LED light fitting is a complete unit comprising the LED(s), a registration strip, a local rectifier and optionally a power line communications chip.

Typically, the LEDs for use in any particular power and lighting system herein are selected for their ability to provide light across the desired wavelength range throughout the commercial and/or domestic application, or at a particular wavelength for provision of a specific colour within a section thereof. Exemplary coloured and broad spectrum LEDs for use herein are independently selected from LEDs capable of providing wavelengths in the range of: from about 400 nm to about 700 nm; about 460 nm to about 640 nm; about 460 nm; about 560 nm; about 640 nm, wherein such wavelengths are provided by the individual LEDs, by one or more LEDs arranged in a group or strip, or by all of the LEDs within the array.

In addition the present system may include one or more UV or IR LEDs, as individual lights, or in groups, having wavelengths of less than about 400 nm or greater than about 760 mn respectively to provide bespoke lighting requirements either in specific segments or throughout a power and lighting system for commercial and/or domestic application.

For the avoidance of doubt, the present power and lighting systems may comprise a mixture of different LED light fittings and/or a mixture of coloured, broad spectrum, UV or IR LEDs having different wavelengths.

The term ‘about’ means that any LED or groups of LEDs which provide wavelengths substantially as defined herein are LEDs suitable for use herein

Thus the present invention provides a novel power and lighting system including: LED strip lighting/LED strip lights; strips containing LED lights; LED spot lights, LED floodlights and mixtures thereof.

### Lighting System Control

As detailed herein the system includes local means for management of LEDs and/or devices within the power and lighting system via use of suitable registration chips and local inverters which may be in the form of a chip. For the avoidance of doubt the automatic correction of voltage drop at any strip within the system is managed by the local inverters on each LED, and the registration chip(s) enable identification and individual and/or group control of LED lights or non-LED devices within the system via a suitable control system.

Whilst the selection of any particular LED lighting will depend upon the requirements of the particular commercial and/or domestic application to be lit, the means by which it can be adapted to operate within the present system are as follows:
1. To enable advantageous system control each LED light, or group or LED lights, or strip of LED lights, or strip containing LED lights is fitted with a registration chip which can be identified and controlled separately. The means by which such chips may be fixed to any particular strip are as detailed hereinbefore and can be applied to chip-affixation to individual LED lights, or groups of LED lights;
2. On installation each LED light is calibrated over the range of input currents and ‘on-off’ pulse widths using a purpose designed spectrometer or spectroradiometer thus enabling the control system to deliver and record the wavelengths, intensities and photoperiods delivered by each LED light, group of LED lights, strip of LED lights, or strip containing LED lights. The means by which such calibration may be carried out are as detailed hereinbefore.

The present control system for the LED array(s) as defined herein uses smart software to manage the data being captured and relayed to the control system from various sources, lighting registration chips, inverter/rectifier monitoring means, power line communications chip, wireless technology, local PCs, or other data capture means, in order to provide tailored monitoring and control of the overall growth system in response to such data capture in real-time.

Thus the present invention additionally provides a method for adapting commercially available LED lighting for use in the novel power and lighting system and for the management and control thereof as defined herein.

In addition to commercially available LED strip lighting, the present systems may include LED-containing T-shaped strips. Such strips are made from Aluminium. Illustrations of such T-shaped LED containing strips are provided in the Figures herein.

Such T-shaped strips are particularly well-suited for hosting upon bus bars. In addition such T-shaped strips may be bent, twisted or otherwise manipulated to provide bespoke LED strips for use herein, provided that the area of the strip to be located upon the bus bars remains intact and in its original form.

Each such T-shaped strip, or group of strips, includes a registration chip and a local invertor which may be in the form of a chip. For the avoidance of doubt the automatic correction of voltage drop at any strip within the system is managed by the local inverters on each strip, and the registration chip(s) enable identification and individual and/or group control of strips within the array(s) via a suitable control system.

As such the present power and lighting systems as defined hereinbefore may include LED arrays comprising one or more LED strips wherein each LED strip incorporates a local registration chip, and a local inverter wherein said LED strips may be independently selected from: individual T-shaped linear aluminium strips containing LEDs, groups of such T-shaped LED strips arranged in parallel, or alternative LED arrays comprising individual T-shaped bent, twisted or otherwise manipulated aluminium T-shaped strips, or groups of such bent aluminium strips containing LEDs in non-parallel arrangements, or groups of bent strips in non-parallel arrangements,

According to one aspect the power and lighting systems as defined herein include LED strips or LED light fittings the LED(s), a registration strip, a local rectifier and optionally a powerline communications chip.

According to an alternative aspect the power and lighting systems as defined herein include LED strips or LED light fittings wherein the individual LED(s) are fitted with a registration strip, and a local rectifier wherein the registration chip provides means for communication with local/repeater wireless technology.

Any LED array which has been made to link to the low voltage AC via a registration chip can be utilised in the in the power and lighting systems herein for commercial and/or domestic applications. The means by which such LED array(s) may be registered are as detailed hereinbefore.

### Bus Bars

The bus bars for use in the present systems employ a positive bus bar and a neutral bus bar running in parallel with one another. The +/− electrical connections from the bus bars to the local rectifiers associated with each LED containing T-shaped strip are effected by any suitable means, and in particular by clips from the bar(s) to each strip. A segment of an exemplary parallel positive and neutral bus bar arrangement is detailed in FIG. 1a.

Advantages of the bus bar arrangement versus present commercially available systems include: two-step voltage inversion; efficiencies of from 90 to 94%; means for self-regulating system control; provision of automatic voltage correction; ability to control arrays containing more than 100,000 LEDs via use of power line technology; more efficient wiring system with only final wiring being required, and being provided via copper wire; provision of a “plug and play” LED array; use of wireless link(s) to local sensors within the system as part of the management and remote-control of features within the array(s).

In addition, as such systems provide unprecedented efficiencies in running costs, versus current 24/7 monitored systems, as well as being less capital intensive to set-up, typically in the region of 30% cheaper, the present growth system provides for the first time a reliable, efficient, controllable and sensitive LED array for use in close proximity to living organisms.

In commercial and/or domestic applications employing the present system the power is initially provided from the transformer into a main bus bar system comprising one or more main bus bars, and thereafter to one or more secondary bus bars, and optionally onto one or more tertiary bus bars. For the avoidance of doubt, and as explained hereinbefore the bus bars as utilised herein employ a positive bus bar and a neutral bus bar running in parallel with one another, and such a main bus bar system comprises one or more main bus bars means one or more positive and neutral bus bars running in parallel with one another. This feature is illustrated in FIG. 1a hereinafter.

Thus the present application provides a power and lighting system for commercial and/or domestic applications as defined hereinbefore wherein the power is distributed via a bus bar assembly comprising a main bus bar system comprising one or more main bus bars, and thereafter to one or more secondary bus bars, and optionally onto one or more tertiary bus bars.

Any suitable bus bars, also known as busbars, buss bars, or bussbars made of conductive material, and in particular metals such as aluminium, copper or brass may be used in the present bus bar assembly. Thus, according to a further aspect the present invention additionally comprises a growth system as defined hereinbefore having conductive bus bars of one or more of Al and Cu or a mixture thereof.

Any suitable shape of such bus bars, including tubular, square or alternative shape(s) as desired may be used.

For the avoidance of doubt the selection of a suitable bus bar, and in particular the wall thickness and/or diameter of the bus bars will be dependent upon the requirements of the particular part of the commercial and/or domestic system in which it is to be employed, both from the viewpoint of providing the necessary levels of support for the LED array(s), as well as for the provision of optimal cost per metre of the particular power loading being provided to and distributed by the bus bar system. As such metal bus bars for use herein can be designed to have large diameters and small wall thicknesses or small diameters and larger wall thicknesses to achieve optimum cost per metre for each power loading (current).

Commercially available tubular bus bars of any suitable diameter and width can be used. For the avoidance of doubt the selection of a suitable bus bar, and in particular the wall thickness and/or diameter of the bus bars will be dependent upon the requirements of the power and lighting system in which they are to be employed, both from the viewpoint of providing the necessary levels of support for the LED array(s), as well as for the provision of optimal cost per metre of the particular power loading being provided to and distributed by the bus bar system. Metal bus bars, including Al and/or Cu busbars, for use herein can be designed to have large diameters and small wall thicknesses or small diameters and larger wall thicknesses to achieve optimum cost per metre for each power loading (current).

Exemplary bus bars for use as the main, or primary, bus bars in the power and lighting systems herein are aluminium bus bars. Aluminium bus bars have particular advantages in some systems as more current is carried on the outside of an aluminium bus bar than for example a copper bus bar, Suitable aluminium bus bars for use herein are commercially available hollow tubular aluminium bus bars, including tubular aluminium bus bars available from Alcomet in a range of outside diameters of from 25 mm up to 250 mm.

Commercially available copper bus bars may be utilised as secondary bus bars in the present power and lighting systems, either as hollow tubular bus bars or as copper wires. Copper wires are particularly suitable for use as tertiary bus bars in the present power and lighting systems. Use of such copper bus bars in the present bus bar assemblies, either as tubes and/or as wires advantageously allows for ease of positioning of the LED lights in their selected spots.

For electrical and heat insulation the bus bars for use in the present systems can be protected with any suitable insulating materials, such as for example heat shrink coatings. Suitable heat shrink bus bar tubing for use herein includes BBIT heat-shrinkable bus bar tubing from Raychem. A section of a coated bus bar is illustrated in FIG. 1a herein.

The main bus bars typically having a vertical or substantially vertical arrangement and can be located externally, internally or centrally. From these main bus bars the power can then be distributed to lighting arrays throughout the system via a secondary bus bar system comprising a series of secondary bus bars, or wires at each floor or level of the building having a horizontal or substantially horizontal arrangement. The tertiary power supply system comprises a series of tertiary bus bars, or copper wires at low voltage AC at each floor or level of the building having a horizontal or substantially horizontal arrangement.

As will be readily appreciated the present system provides for desirable flexibility in design of the bus bar assemblies for domestic and/or commercial applications, with the relative arrangements of the main, secondary and tertiary bus bar systems providing the ability to build-in bespoke power and lighting systems which are cost-effective, efficient and controllable. The size of the bus bars (diameter) is reduced between the main and secondary system, and again between the secondary and tertiary system. This feature is illustrated in FIGS. 1 and 1a.

Typically the power for the LED lighting is distributed by the secondary bus bar arrangement and as such in the majority of cases this arrangement will be located towards the ceiling or roof of the room, or office, or warehouse or other section of the domestic and/or commercial building, although the system does include the capacity for the lighting to be provided from bus bars connected to walls, or other structures to provide lighting from alternative perspectives than simple downward arrangements. Where the system requires, the secondary bus bar arrangement may be linked to a tertiary bus bar arrangement to further distribute power to the lighting.

The tertiary bus bars or copper wiring at low voltage further distributes the power from the secondary bus bars to the LEDs, as detailed hereinbefore as well as to non-LED devices as also defined hereinbefore. Again, for the non-LED devices the design freedom provided by the present system allows these bus bars to be located according to the bespoke needs of the building users, but most commonly, where tertiary bus bars provided for power distribution to non-LED devices will be located at or close to the floor at each level of the commercial and/or domestic building. For certain rooms, such as kitchens the tertiary system may be advantageously located above workbench/kitchen unit height.

The bus bars for use in the commercial and/or domestic arrangements herein include; tubular bus bars; aluminium tubular bus bars; copper bus bars. The present systems may employ different bus bars for each of the main, secondary and tertiary bus bar arrangements, or the same material for each, or any other combination of suitable bus bar materials according to the requirements of the particular power and lighting system.

According to a further aspect the power and lighting systems as detailed hereinbefore may additionally comprise a coated bus bar assembly wherein the coated positive and neutral bus bar components of each of the main and secondary bus bars run in parallel to one another, and wherein the main bus bars are provided in a substantially vertical arrangement and wherein the secondary bus bars are provided in a substantially horizontal arrangement.

Suitable bus bars for use herein are coated bus bars, and more particularly plastic coated bus bars. Where one bus bar system is to be connected to another bus bar within a bus bar assembly for use in the present power and lighting system, for example to make a connection from the secondary bus bars to the main bus bars, the connection may be effected by baring the plastic at the desired connection point of the main bus bar to expose the metal and connecting a correspondingly exposed metal aspect of the secondary bus bar thereto. Where an electrical connection is to be effected, such as for final wiring of the low voltage wiring (which is connected to the LED light(s), LED strip(s), strips containing one or more LED lights) to the secondary bus bars, then a connection point may be drilled into the secondary bus bar.

In systems where the main transformer is externally located and the main bus bar system is either fully or partially externally located then the main bus bar is optionally further coated with a suitable thermal insulation/environmental protective layer.

According to a further aspect the present invention provides additional means for protecting the lighting arrangements in systems having bus bars against electrical surges. In addition to the transformer related surge protection equipment on the high voltage side of the transformer as detailed hereinbefore, the system additionally comprises watchdog-type technology, as defined hereinbefore, on the low voltage side of the transformer which compares the actual power being used on each bus bar to that predicted by the software. Variances from the pre-set levels can be incorporated into the control system to show as an alarm and any pre-set large variances can be configured to trip the power to the particular bus bar, or group of bus bars which are out of compliance with the pre-set power distribution levels in order to protect the overall system.

Watchdog-type technology as defined herein means equipment which is both compatible with the control system being operated for any particular system herein and which is capable of monitoring power consumption and distribution levels at one or more point within the power distribution apparatus (bus bars/wiring) of the present systems in real time. Any suitable monitoring equipment such as a power meter can be used.

As a further feature suitable conventional fuses can also be installed to provide an additional safety measure should the power levels being distributed to any particular bus-bar, or group of bus bars within the system exceed a pre-determined level. For the avoidance of doubt such pre-determined level may vary depending upon the nature of the specific system, and the relevant breaking capacity/interruption rating of the particular fuse selected for use.

Thus the present invention provides a novel lighting system suitable for commercial or domestic use in accordance with any of the aspects defined herein wherein the system additionally comprises provides means for protecting the lighting arrangements in systems from electrical power surges wherein said means comprises the combined use of surge protection equipment, watchdog timer equipment and optionally one or more fuses.

As previously discussed the present invention provides a power and lighting system wherein the lighting may include LEDs hosted on a T-shaped host strip and wherein said strips are hosted upon bus bars and are conduct the low voltage AC power from the bus bar to the LEDs, thereby acting as secondary, or tertiary bus bars.

Each individual LED strip comprises an arrangement of one or more LEDs which are connected to one another by suitable AC wiring and wherein the LED strips are co-located with and are adjoined to a suitable substantially T-shaped host strip. Suitable host strips are substantially ‘T’ shaped for strength, are light weight and typically less than 20 mm wide. The T-shaped host strips may be made of any suitable material which has sufficient strength to support the LEDs during the lifetime of the strip, LED or system. An exemplary T-shaped host strip material herein is Aluminium.

The number of LEDs on each strip can be as little as one, with the maximum number being determined by the DC voltage available from the rectifier divided by the forward voltage required by each LED. For example, at the maximum safe voltage of 50 v AC RMS which would convert to 74 v DC with a typical red LED forward voltage of 2.2 this would be 33 LEDs.

Each LED is surface-mounted on to the aluminium T strip by a thermally efficient adhesive bonding a solder pad housing the LED chip. Each solder pad is hard-wired using insulated copper wiring and each LED is wired in series.

As detailed hereinbefore further advantages of the controllable, low cost, high efficiency, power and lighting systems of the present invention which include one or more LED lighting arrays and one or more non-LED devices are the ability to build-into such systems unique identifying information and the ability to drive-down installation and running efficiency costs yet further via the utilisation of power line technology.

### Data Management

As discussed hereinbefore, according to a yet further aspect the present invention provides a control system for lighting devices and non-lighting devices within the system as defined herein wherein the lighting control system includes means for logging of data for measurement of radiant power and wherein the non-lighting control system includes means for logging of data for measurement of power consumption.

For the LED lighting system for use in the power and lighting system of the present invention, advantageously the lighting control system includes means for logging of data for measurement of the radiant power of the LED array as a whole, or individual LEDs, or groups of LEDs within the array without continuous spectroradiometry.

Thus by linking the LED array control system to movement sensors and light sensors an overall control system providing real-time or periodic data-sets which enable progressive/on-going of optimisation and/or maintenance of pre-defined output levels within the system can be achieved.

Thus according to a further aspect the present invention provides a controllable power and lighting system for providing effective light levels to a commercial or domestic system via an LED array as defined herein before and wherein it is a feature of said control system that there is no need for on-going measurements of the LED wavelengths, intensities or photo periods.

According to a yet further aspect said control system can be linked to a natural light meter to enable the controls to adjust the LEDs as light levels change within the commercial or domestic environment.

A particular feature of this invention is the ability to power the LEDs at a voltage that is safe for operatives/maintenance personnel. This is achieved by connecting the lighting system to an AC low voltage power supply, between 12-50 v AC, typically 24-36 v AC which is provided to the system via bus bars. A further safety advantage provided by the present power and lighting system versus those currently available is that once installed operatives responsible for day-to-day maintenance of the building can safely install and maintain all the LEDs, because they are operating at only low voltage AC. This leads to commercial operating cost reductions. The overall efficiency of the LED array can be controlled to maintain operational voltages which optimise the rectification.

Thus according to a further aspect there is provided herein a control system for use in a power and lighting system comprising one or more LED arrays and one more non-LED devices as defined herein wherein the control system includes means for logging of data for: measurement of: the radiant power of the LED array as a whole, or individual LEDs, or groups of LEDs within the array; measurement of light levels within the building, or section or floor of the building in which the power and lighting system is employed via light sensors; measurement of power levels to one or more, LEDS, groups of LEDs within the array, and/or individual or groups of non-LED devices within the power and lighting system and wherein said control system provides means for control of the operational voltages to maintain efficiency of 90% or above.

As discussed hereinbefore the present invention additionally provides means for independent control of each individual LED, or group of LEDs within the power and lighting system which may contain LEDs of different wavelengths. This is achieved with low voltage control lines, power line technology or wireless technology, commanded by a central microcontroller. This microcontroller also acts as the gateway for traditional Personal Computer (PC) communications. This data can be arranged to vary the intensity or radiant power at each wavelength and photoperiod either by varying the current or by incorporating PWM. The method of communications between the gateway (microcontroller) and PC can be through hard wired means serial or Ethernet etc., or wireless, via Wi-Fi, snap, Zigbee, Xbee and other wireless protocols.

The ability to control the intensity and the photoperiod of each wavelength on each strip allows for feedback loops to vary the LEDs according to the ambient light conditions in a pre-determined are of the commercial or domestic system in which the present power and lighting system is employed. Such pre-determined area can be an entire building, one or more rooms or spaces within a building such as for example, corridors, and stairwells within a building, groups of rooms or spaces, or one of more floors, or any other arrangement as desired. This allows for the optimum use of power by optimising the LED photon production.

An optimisation process can be employed once the system has been installed and the building is in use, such an evolutionary optimisation process would enable lighting needs across a specified period (minutes, hours, days, weeks, months) to be assessed by the use of light and/or movement sensors with the resultant data being collected via the control system. Processing of this data would provide the base-line pre-set lighting levels across the specified period which can then be monitored and controlled for on-going efficient light level delivery by linkage of the control system to imaging and light sensing equipment allowing feed-back loops to control the light in real time.

This approach, when compared to HID sodium lamps or fixed output LED arrays will reduce the requirement for heating in commercial and domestic buildings.

### FIGURES

Representative examples of power and lighting systems suitable for use in commercial and/or domestic applications having aluminium bus bars, at low voltage AC, used to power LED lights, individually or in groups, within one or more LED array and the capacity to power non-LED devices where ‘power line’ technology, provided via the bus bars, provides a control system for the lighting system, and wherein the control system communicates with each individual LED light/group or array, or non-LED devices via use of one or more registration chips for identification, as well as particular aspects of features of such systems are illustrated in and are discussed in relation to the Figures presented hereinafter.

For the avoidance of doubt, whilst these Figures illustrate the utility of a power and lighting system in accordance with aspects of the invention within specific commercial or domestic environments, the particular features of the power distribution system and LED arrays illustrated therein and as discussed herein after are equally applicable for use in alternative commercial and/or domestic arrangements. As such the following provide representative examples of particular embodiments of an aspect of the present invention and are not intended to be limiting thereon.

### DESCRIPTION OF THE FIGURES

FIG. 1: illustrates a small office block (18) having multiple floors wherein the main AC transformer (3) is located externally and on the top of the building, this large AC to AC transformer (3) receives power from any suitable source of 240 v AC such as a power line, a source of solar power, renewable power sources such as wind power. The main bus bar (19) is plastic-coated (as illustrated in FIG. 17a), and as indicated by the thicker line, is provided with a further insulating/protective coating from the connection to the main AC transformer at the top of the building to the point of entry into the building (18). The transformer converts this 240 v AC input power to less than 50 v AC RMS prior to entry into the building (18) wherein the so-converted power is distributed throughout each level of the building, i.e. to each office floor within the building (not labelled) as well as the basement, via a system of bus bars (19). At each level power is provided to the LED arrays (2) at each level via secondary bus bars (19b) which link the LED strips within the array(s) together.

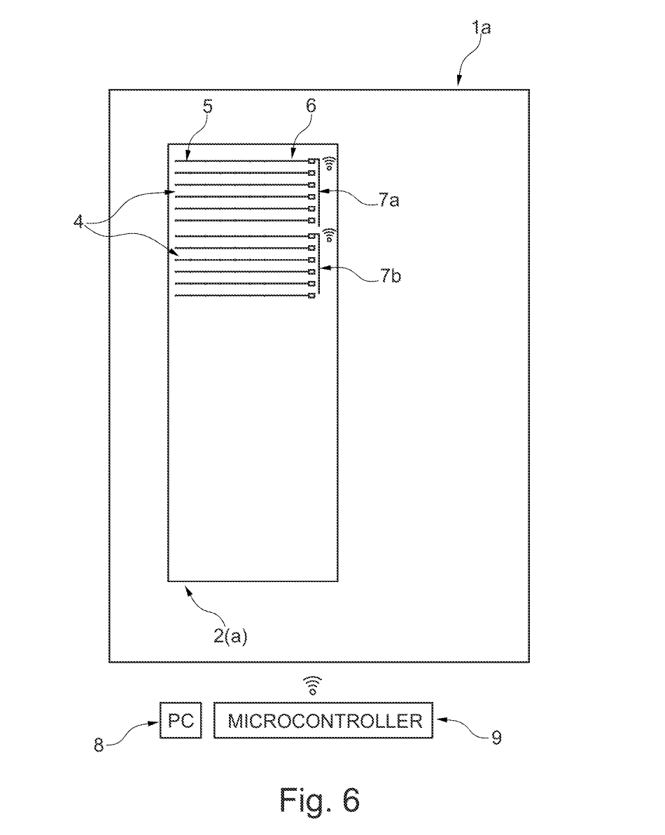

As illustrated in FIG. 6 via each individual LED strip (5) or group of LED strips (4) within the array(s) of FIG. 1 can be individually controlled ultimately via the internet with all data collected via the cloud.

FIG. 1 also illustrates a the use of powerline technology (9a) and a central microcontroller (9) which is wireless enabled is linked to a local PC (not illustrated) and each LED strip or more typically each group of strips within the array(s) receives the wireless signal and distributes the command to each individual strip via the series of secondary bus bars (19b) which link the strips together. The wireless signals are two-directional and able to send commands and collect data from local sensors and other monitoring equipment.

FIG. 1a: illustrates a detailed view of the coated positive and coated neutral bus bar component running in parallel to one another in a section of the secondary tubular coated bus bar (19b) of FIG. 1. FIG. 1a also illustrates an expanded view of a section of the primary (19) and secondary (19b) components of the bus bar assembly in the lower levels of the building and shows the coated positive and coated neutral bus bar components of each of the main and secondary bus bars which running in parallel to one another, and illustrates the substantially vertical arrangement of the pair of main bus bars, and the substantially horizontal arrangement of the two-pairs of secondary bus bars in each of the two building levels of FIG. 1a. A further transformer (3) and powerline technology (9a) are also illustrated in FIG. 1a.

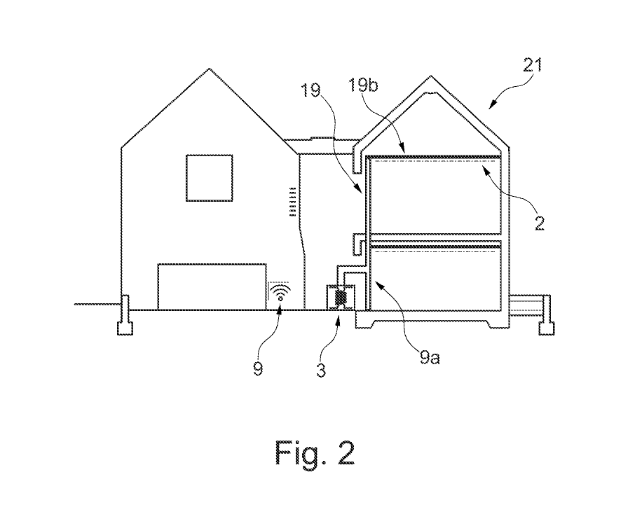

FIG. 2: illustrates a domestic building (21) having two floors wherein the main AC transformer (3) is located externally and at the side of the building, this large AC to AC transformer (3) receives power from any suitable source of 240 v AC in the same manner as indicated for the small office block of FIG. 1 and converts the 240 v AC input power to less than 50 v AC RMS prior to entry into the building (21) wherein the so-converted power is distributed throughout each floor of the house, via a system of main bus bars (19) with power being provided to the LED arrays (2) at each level via secondary bus bars (19b) which link the LED strips within the array(s) together. For the avoidance of doubt the LEDs within this system are controllable in accordance with the arrangement as illustrated in FIG. 6, and as detailed in relation to the small office block of FIG. 1.

A central microcontroller (9) which is wireless enabled is linked to a local PC (8) (not illustrated) and each LED strip or more typically each group of strips within the array(s) receives the wireless signal and distributes the command to each individual strip via the series of secondary bus bars (19b). These wireless signals are two-directional and able to send commands and collect data from local sensors and other monitoring equipment. Powerline technology (9a) is also illustrated in FIG. 2.

Whilst the internal LED and power arrangement in building (21) is illustrated for the right hand side of the building only, it will be appreciated that the system is fully operable throughout the entire building via appropriate bus bar, LED array(s) and low voltage wiring linked to microcontroller (9).

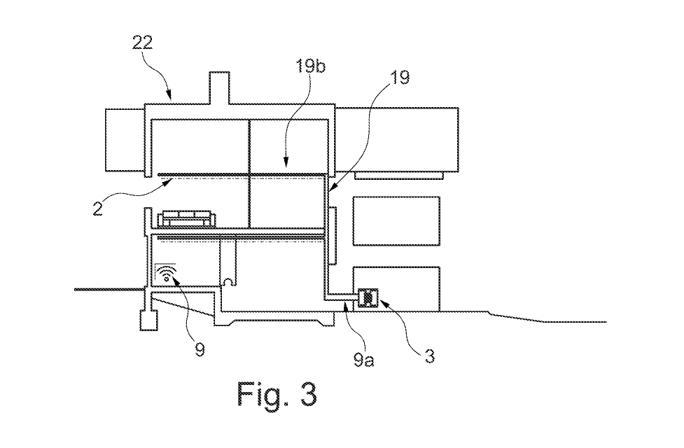

FIG. 3: illustrates a domestic building (22) having two floors wherein the main AC transformer (3) is located externally and at the side of the building, this large AC to AC transformer (3) receives power from any suitable source of 240 v AC in the same manner as indicated for the small office block of FIG. 1 and converts the 240 v AC input power to less than 50 v AC RMS prior to entry into the building (22) wherein the so-converted power is distributed throughout each floor of the house, via a system of main bus bars (19) with power being provided to the LED arrays (2) at each level via secondary bus bars (19b) which link the LED strips within the array(s) together. For the avoidance of doubt the LEDs within this system are controllable in accordance with the arrangement as illustrated in FIG. 6, and as detailed in relation to the small office block of FIG. 1.

A central microcontroller (9) which is wireless enabled is linked to a local PC (8) (not illustrated) and each LED strip or more typically each group of strips within the array(s) receives the wireless signal and distributes the command to each individual strip via the series of secondary bus bars (19b). These wireless signals are two-directional and able to send commands and collect data from local sensors and other monitoring equipment. Powerline technology (9a) is also illustrated in FIG. 3.

Whilst the internal LED and power arrangement in building (21) is illustrated for the left hand side of the building only, it will be appreciated that the system is fully operable throughout the entire building via appropriate bus bar, LED array(s) and low voltage wiring linked to microcontroller (9).

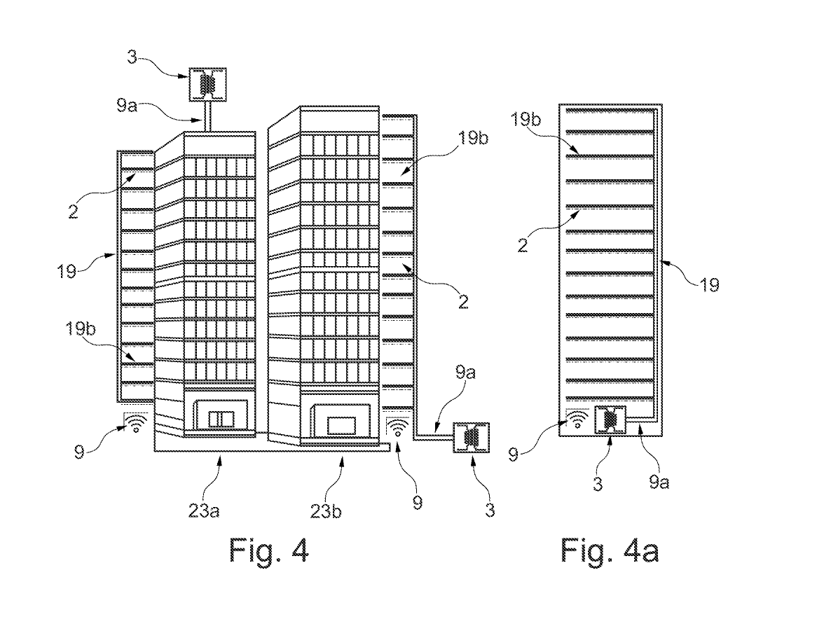

FIG. 4: illustrates two of commercial office blocks (23a) and (23b) having a combined power and lighting system wherein the main AC transformer (3) is located externally and on top of block (23a), this large AC to AC transformer (3) receives power from any suitable source of 240 v AC in the same manner as indicated for the small office block of FIG. 1 and houses of FIGS. 12 and 13 to convert the 240 v AC input power to less than 50 v AC RMS prior to entry into block (23a) wherein the so-converted power is distributed throughout each floor of the block, via a main bus bar arrangement (19) with power being provided to LED arrays (2) at each level via secondary bus bars (19b) which link the LED strips within the array(s) together. For the avoidance of doubt the LEDs within this system are also controllable in accordance with the arrangement as illustrated in FIG. 6, and as detailed in relation to the small office block of FIG. 1.

Local microcontrollers (9) which are wireless enabled are located within each building and are linked to a local PC (8) (not illustrated) and each LED strip or more typically each group of strips within the array(s) receives the wireless signal and distributes the command to each individual strip via the series of secondary bus bars (19b) which link the strips together. These wireless signals are two-directional and able to send commands and collect data from local sensors and other monitoring equipment.

Whilst the internal local microcontrollers in blocks (23a) and (23b) are shown at ground level, it should be appreciated that this can be located at any suitable position within the blocks which are convenient.

For the purposes of illustration only, the internal power distribution and lighting arrangement in block (23a) comprising a main bus bar (19) which distributes power to the LED arrays (2) from a main transformer (3) at the top of block (23a) via a series of main bus bars (19) and secondary bus bars (19a), with control of the block being provided by powerline technology (9a) and a local microcontrollers (9) is shown in an exploded view at the left hand side of the building. Similarly the internal power distribution and lighting arrangement provided from a further transformer (3) to main bus bar assembly (19) and thereby to, a series of secondary bus bars (19a), and LED arrays (2), with control of block (23b) being provided by powerline technology (9a) and a local microcontroller (9) is also shown in exploded view on the left hand side of the building.

For the avoidance of doubt, the remote-control of either of blocks 23a or 23b may be managed separately or individually using the control system herein.

FIG. 4a provides an expanded view of the internal system within block (23a)

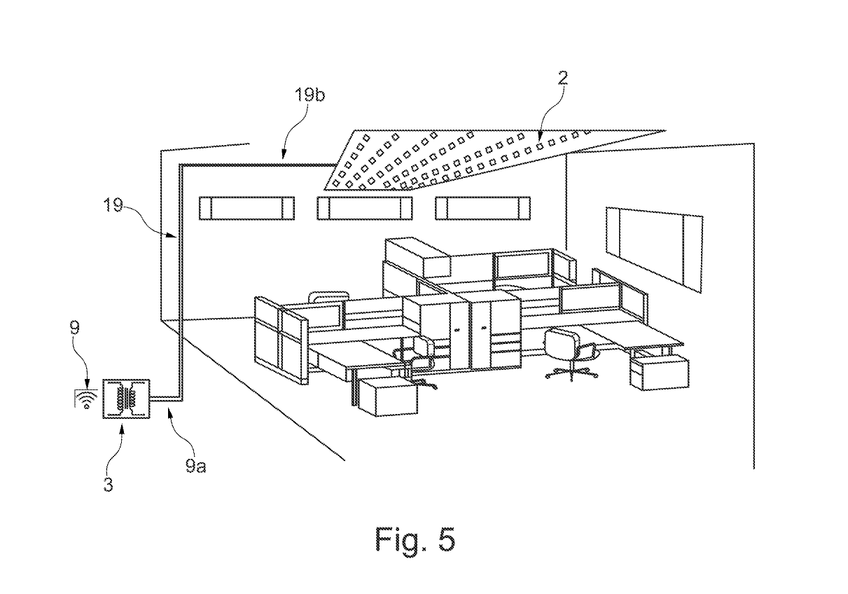

FIG. 5: illustrates a single office within block (23a) of FIG. 4, and in particular a suspended LED array (2) with power distributed from a transformer (3) via a main bus bar arrangement (19) and secondary bus bar arrangement (19b) with wireless system control and management being provided by microcontroller (9) and power line technology (9a).

FIG. 6: illustrates an arrangement of six strips (5) of LEDs, arranged in a group (4) with control wire (7), wherein the local microcontroller (not illustrated) is located within PC (8), wireless functionality (10) and rectifiers (6). FIG. 4 also illustrates the connectivity and flow of current through the illustrated section from and back to the transformer (3).

1. A controllable power and lighting arrangement for commercial and/or domestic use comprising an LED array comprising LED lights wherein the array is powered by an AC low voltage power supply
(i) wherein the low voltage AC power distributed to the array is linked to an external transformer;
(ii) wherein the low voltage AC power is distributed by bus bars;
(iii) wherein the low voltage AC supplied to each strip is converted to low voltage DC at an AC/DC rectifier associated with each strip; and
(iv) wherein the system includes means for automatic control of the output of the LED array as a whole or individual LED lights, or groups of LED lights within the array.

2. A system according to claim 1, wherein the main AC transformer is located externally or internally and wherein the main internal AC transformer may be positioned centrally or at the top or at the bottom of the building and the main external AC transformer may be positioned at a central location.

3. A system according to claim 1, wherein the bus bars are adapted to power one or more non-LED based devices within the system.

4. A system according to preceding claim 1, wherein the array comprises one or more LED lights, including: one or more LED spotlights, one or more LED floodlights, one or more LED strip lights, or one or strips containing LED lights, or any combination of LED spotlights, LED floodlights, LED strip lights, or strips containing LEDs.

5. A system according to claim 1, additionally comprising power line technology in combination with communications, registration and inverter chips within the array wherein the system can be monitored and controlled remotely.

6. A controllable system according to claim 1 containing LED lights and non-LED devices, wherein the LED lights and non-LED devices are powered by an AC low voltage power supply and wherein the power is distributed by bus bars.

7. A system according to claim 6 wherein the control system is provided by powerline technology provided by the bus bars, and wherein each LED light within the system is registered.

8. A system according to claim 1, wherein the system can be monitored and controlled wirelessly and remotely.

9. A system according to claim 1, wherein the low voltage power supplied to the bus bars is between 12 v and 50 v AC RMS.

10. A system according to claim 1, wherein the low voltage AV power is distributed by aluminium tubular bus bars.

11. A system according to claim 1, wherein the low voltage AC supplied to each LED light is converted to low voltage DC at an AC/DC rectifier associated with each light.

12. A system according to claim 1, additionally incorporating means for measurement of the radiant power of the LED array or individual LEDs, or groups of LEDs within the array.

13. A system according to claim 12, wherein said means is provided by a control system for measurement of radiant power provided by registration of each LED within the array and pre-calibrated of the LEDs by spectroradiometers.

14. A system according to claim 1, wherein the wavelengths provided by the LEDs within the array are from 400 nm to 700 nm.

15. A system according to claim 1, wherein the one or more non-LED devices are individually selected from: laptops; personal computers (PCs); printers; scanners; dictation machines; telephone answering machines; chargers including mobile-phone chargers, tablet chargers, mobile gaming device chargers, camera and video chargers; TVs; monitors; shavers; hair trimmers; radios; smoke alarms/detectors; CO₂ alarms/detectors; security alarms and motion sensors; and any combination thereof.

16. A system according to claim 1, wherein the control system includes means for logging of data for: measurement of: the radiant power of the LED array as a whole, or individual LEDs, or groups of LEDs within the array via calibration; measurement of light levels within the commercial or domestic area via light sensors; measurement of the power input to/power consumption of non-LED devices, either individually or in groups.

17. A system according to claim 1, wherein the control system for the non-LED device(s) comprises a registration chip incorporated into the device lead or plug.

18. A system according to claim 1, wherein the non-LED device(s) is connectively attached to the low voltage power system via an inverter/controller incorporated into the device lead or plug.

19. Use of a system according to claim 1, for provision of: commercial lighting; domestic lighting; street lighting wherein the low voltage AC power is distributed by tubular bus bars

20. A device lead or plug suitable for use in the power and lighting systems of claim 1 comprising an inverter/controller and optionally a registration chip.
